(19) United States
(12) Patent Application Publication
(10) Pub. No.: US 2026/0268014 A1
(43) Pub. Date: Sep. 10, 2026

(54) Privacy-Preserving Domain Integration for Federated Learning

(71) Applicant: Oracle International Corporation, Redwood City, CA (US)

(72) Inventor: Wei Jiang, Nolensville, TN (US)

(21) Appl. No.: 19/073,891

(22) Filed: Mar. 7, 2025

(51) Int. Cl. G06F 21/62; G06F 21/60

(52) U.S. Cl. CPC G06F 21/6245; G06F 21/602; G06F 21/6227

(57) ABSTRACT

Systems and methods for implementing privacy-preserving aggregation of federated data are disclosed. Clients may share sets of private values encoded in different local domains with an aggregator, where privacy of the local domains is preserved. The aggregator merges the shared sets into an aggregated set that includes non-unique values and derives a global domain for the aggregated set. The aggregator then shares mappings between input sets and the global domain with the respective clients while preserving privacy for the global domain. The clients may then encode private datasets for aggregation using the respective mappings.

### BACKGROUND

### Field of the Disclosure

This disclosure relates generally to computer hardware and software, and more particularly to systems and methods for implementing machine learning systems.

### Description of the Related Art

Domain knowledge is often required to build accurate machine learning (ML) models, yet feature domain integration is an often overlooked problem in federated learning applications where data is horizontally partitioned among multiple data owners. Existing privacy-preserving machine learning (PPML) techniques generally assume that, prior to building a machine learning (ML) model, data owners can execute a privacy-preserving or private set union (PSU) protocols to produce a global feature domain. Subsequently, the global domain is shared with the data owners to allow them pre-process the feature according to specific techniques such as one-hot encoding. However, a PSU protocol may leak information about each party's local feature domain which may violate data privacy or confidentiality.

### SUMMARY

Methods, techniques and systems for implementing privacy-preserving aggregation of federated data are disclosed. Clients may share sets of private values encoded in different local domains with an aggregator, where privacy of the local domains is preserved. The aggregator merges the shared sets into an aggregated set that includes non-unique values and derives a global domain for the aggregated set. The aggregator then shares mappings between input sets and the global domain with the respective clients while preserving privacy for the global domain. The clients may then encode private datasets for aggregation using the respective mappings.

### BRIEF DESCRIPTION OF THE DRAWINGS

FIG. 1 is a block diagram illustrating a system that includes an aggregator implementing privacy-preserving domain integration, according to at least one embodiment.

FIG. 2 is a block diagram illustrating an execution sequence of system that includes an aggregator implementing privacy-preserving domain integration, according to at least one embodiment.

FIG. 3 is a flow diagram illustrating at least one embodiment of a method for aggregating private local domains into a private global domain.

FIG. 4 is a flow diagram illustrating at least one embodiment of a method for aggregating private local datasets into a private global dataset.

FIG. 5 is a flow diagram illustrating at least one embodiment of a method for eliminating non-unique values of a domain.

FIG. 6 is a flow diagram illustrating an alternative embodiment of a method for eliminating non-unique values of a domain with increased domain security.

FIG. 7 is a block diagram illustrating one embodiment of a computing system that is configured to implement privacy-preserving domain integration, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112 (f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Domain knowledge is often required to build accurate machine learning (ML) models. When data is horizontally partitioned among multiple parties or data owners, it is important for the parties to agree on a global feature space before performing feature engineering tasks. Otherwise, the data owners will not be able to consistently pre-process, or encode, their data which will likely lead to inaccurate ML models. One such pre-processing, or encoding, step is one-hot encoding, an encoding technique where categorical variables are represent as numerical values in a machine learning model. Each party's local one-hot encodings cannot be mapped consistently without knowing the global attribute domain. For example, a first party may have an attribute whose possible values may include “normal” and “low” while a second party may have a same attribute whose possible values may include “normal” and “high”. Without a global attribute domain defining at least three possible values for the attribute, not only will the different parties be unable to provide a globally compatible encoding for the attribute, it is possible that local one-hot encodings for the shared “normal” value may be inconsistent.

Existing privacy-preserving machine learning (PPML) techniques generally assume that, prior to building a machine learning (ML) model, data owners can execute a privacy-preserving or private set union (PSU) protocols to produce a global feature domain. Subsequently, the global domain is shared with the data owners to allow them to pre-process the feature according to specific techniques such as one-hot encoding. However, a PSU protocol may leak information about each party's local feature domain which may violate data privacy or confidentiality. Thus, a need arises for secure domain integration protocols. Instead of directly using PSU, set union operations may be integrated into a feature domain integration protocol such that the global domain is hidden from each data owner. Such protocols may provide that each party's private data is not disclosed to the other parties, that each attribute domain, including domain name, size and ordering of attribute values, are not exposed to aggregation servers and that the global attribute domain, domain size and ordering of the attribute values are not disclosed to the parties or the data owners.

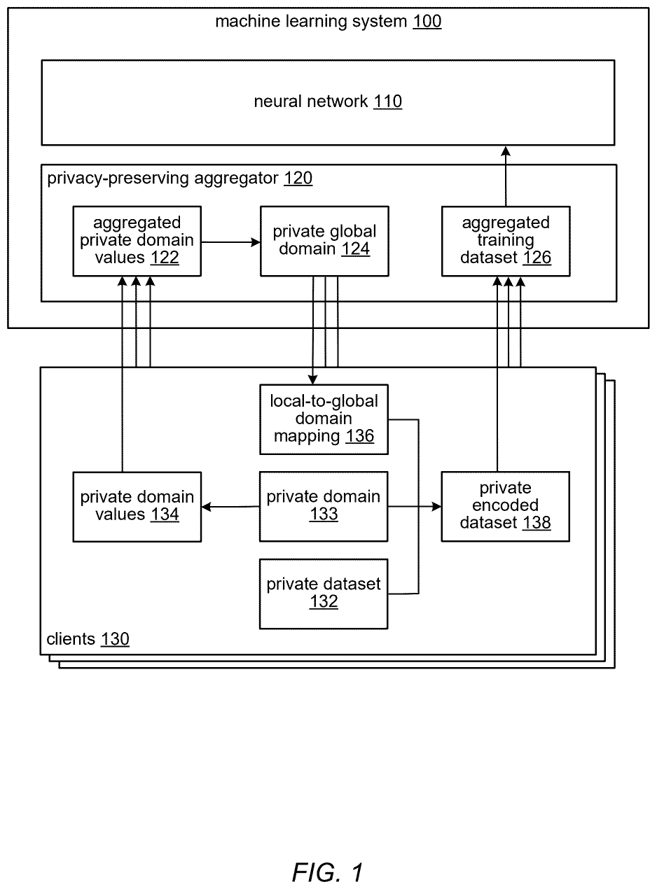

FIG. 1 is a block diagram illustrating a system that includes an aggregator implementing privacy-preserving domain integration, according to at least one embodiment. To train a neural network 110, a machine learning system 100 may, in at least one embodiment, aggregate a training dataset 126 from multiple private dataset sources of clients 130. To accomplish this aggregation, in at least one embodiment a machine learning system 100 may include a privacy-preserving aggregator 120. In various embodiments, privacy-preserving aggregator 120 may be implemented as a single server, a server cluster or multiple servers that employ secure multi-party computation (MPC), a cryptographic protocol that distributes a computation across multiple servers where no individual server can see data of other servers or a complete set of data. Using MPC, no individual device or entity may have access to private data of individual clients 130, as MPC secures private data, or secret data, by splitting processing into multiple parts such that no single participant knows underlying truths. With MPC, no single participant can reconstruct or leak secret information.

In at least one embodiment, different clients 130 may have private datasets 132, where individual data records may each include a number of attributes and each attribute may have a number of possible values. The collective attributes and values of private datasets 132 may define private feature domains 133, in at least one embodiment. While descriptions contained herein discuss aspects of a single attribute, it should be understood that private datasets 132 may individually contain large numbers of records, each with potentially many attributes, leading to thousands, millions or even billions of unique attributes and attribute values. Thus, while descriptions of various embodiments are directed to single attribute, it should be understood that this simplification is not intended to be limiting. Furthermore, it should be understood that differences in various embodiments may have significant impacts in computational performance and efficiency of the machine learning system 100 as global feature domains 124 grow increasingly large.

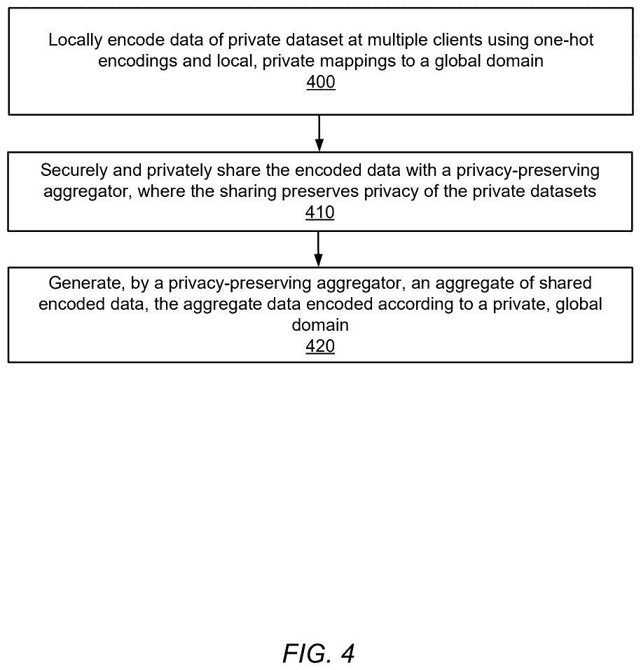

Each client 130 may locally pre-process a private dataset 132 to generate private encoded dataset 138 for integration into an aggregated training dataset 126, in at least one embodiment. This process is discussed in detail below in FIG. 4. To perform this pre-processing, a local-to-global domain mapping 136 must first be obtained by a client 130. To obtain local-to-global domain mapping 136, a client may, in at least one embodiment, generate and privately share private domain values 134 using private dataset 132 and private domain 133. In at least one embodiment, privacy-preserving aggregator 120 may aggregate private domain values 134 of collective clients 130 to generate aggregated private domain values 122 and derive a private global domain 124. In various embodiments, techniques may be employed to ensure privacy of individual ones of the private domain values 134 such that information may not be leaked to the privacy-preserving aggregator 120, the machine learning system 100 or other entities. Likewise, the derived private global domain 124 may, in at least one embodiment, not be disclosed to outside parties, including clients 130 to preserve privacy of the private global domain 124 and individual ones of the private domains 133.

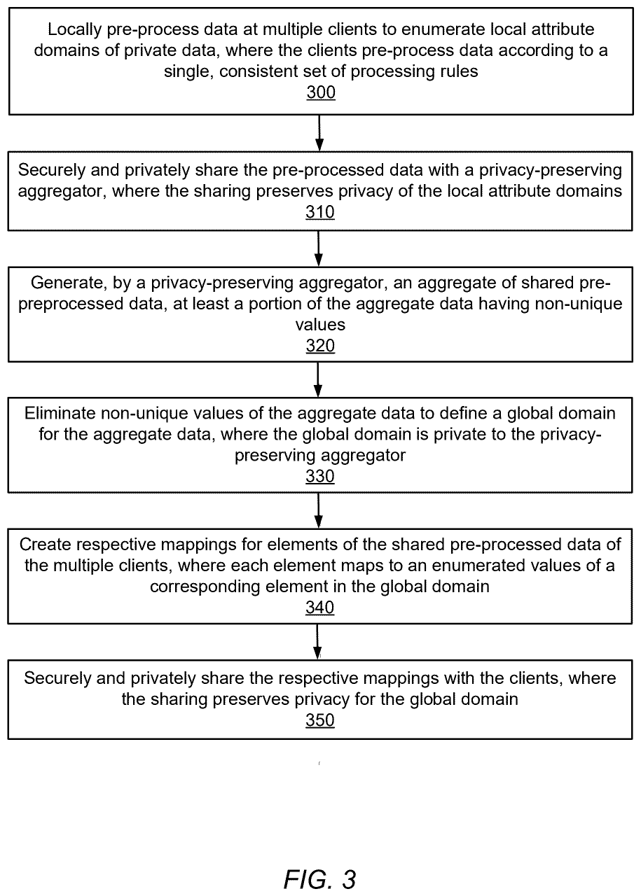

Once private global domain 124 is derived, in at least one embodiment privacy-preserving aggregator 120 may share local-to-global mappings 136 to respective one of the clients by creating mappings between private global domain 124 and respective private domains 133 of individual clients 130. At least one embodiment of a process of generating local-to-global mappings 136 is discussed in greater detail below in FIG. 3.

Once local-to-global mappings 136 are generated, in at least one embodiment individual clients 130 may locally pre-process private datasets 132 to generate private encoded datasets 138 and share those generated datasets with privacy-preserving aggregator 120. Then, in at least one embodiment privacy-preserving aggregator 120 may aggregate the collective datasets into an aggregated training dataset 126 to train one or more neural networks 110.

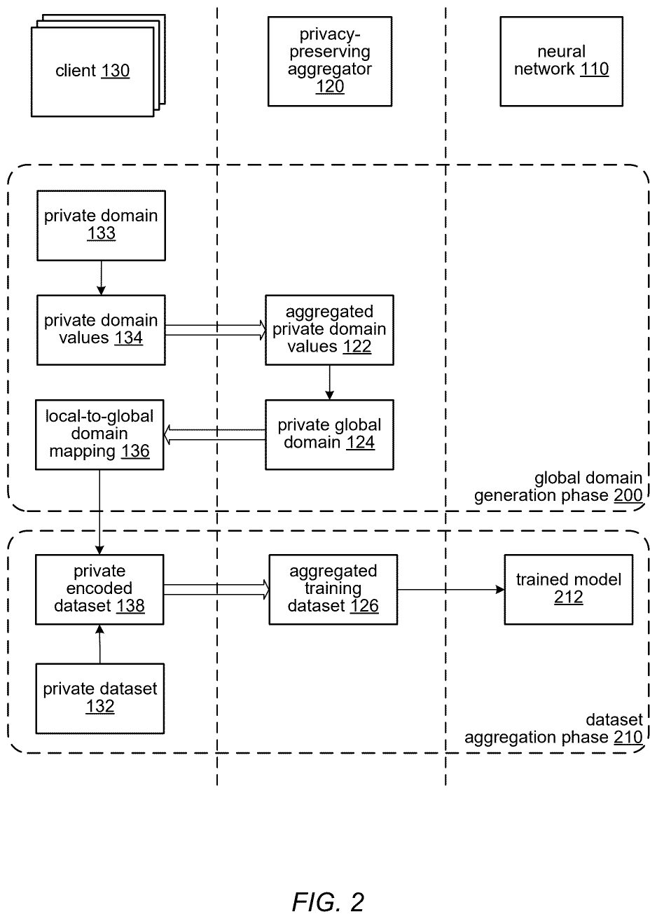

FIG. 2 is a block diagram illustrating an execution sequence of system that includes an aggregator implementing privacy-preserving domain integration, according to at least one embodiment. In at least one embodiment, a process of aggregating a dataset for training of a machine learning system may occur in two phases, a global domain generation phase 200 and a dataset aggregation phase 210. As shown in FIG. 2, dataset aggregation phase 210 completes with training a machine learning model withing a machine learning system, such as machine learning system 100 as shown in FIG. 1, however it should be understood that dataset aggregations may be used for a number of purposes beyond machine learning training and training of a machine learning model is not intended to be limiting. Global domain generation phase 200 is discussed in detail below in FIG. 4 while dataset aggregation phase 210 is discussed in detail below in FIG. 3.

In at least one embodiment, clients 130 may locally pre-process private datasets 132 to generate private encoded dataset 138 for integration into an aggregated training dataset 126. To perform this pre-processing, a local-to-global domain mapping 136 must first be obtained by a client 130.

In at least one embodiment, a global domain generation phase 200 may first be performed. Clients 130 may, in at least one embodiment, generate and privately share private domain values 134 using private domain 133. In at least one embodiment, privacy-preserving aggregator 120 may then receive shared private domain values 134 from clients 130 and aggregate private domain values 134 of the collective clients 130 to generate aggregated private domain values 122. In at least one embodiment, privacy-preserving aggregator 120 may then use aggregated private domain values 122 to derive a private global domain 124.

In various embodiments, techniques may be employed to ensure privacy of individual ones of the private domain values 134 such that information may not be leaked to the privacy-preserving aggregator 120, the machine learning system 100 or other entities. Likewise, the derived private global domain 124 may, in at least one embodiment, not be disclosed to outside parties, including clients 130 to preserve privacy of the private global domain 124 and individual ones of the private domains 133.

Once private global domain 124 is derived, in at least one embodiment privacy-preserving aggregator 120 may generate and share local-to-global mappings 136 to respective one of the clients 130, the shared mappings generated by determining respective mappings between private global domain 124 and individual private domain values 134 of individual clients 130.

Once local-to-global mappings 136 are generated, in at least one embodiment dataset aggregation phase 210 may then be performed. In at least one embodiment, different clients 130 may have private datasets 132, where individual data records may each include a number of attributes and each attribute may have a number of possible values. The collective attributes and values of private datasets 132 may define private feature domains 133, in at least one embodiment. While descriptions contained herein discuss aspects of a single attribute, it should be understood that private datasets 132 may individually contain large numbers of records, each with potentially many attributes, leading to thousands, millions or even billions of unique attributes and attribute values. Thus, while descriptions of various embodiments are directed to single attribute, it should be understood that this simplification is not intended to be limiting. Furthermore, it should be understood that differences in various embodiments may have significant impacts in computational performance and efficiency of the machine learning system 100 as global feature domains 124 grow increasingly large. In at least one embodiment, individual clients 130 may locally pre-process private datasets 132 to generate private encoded datasets 138 according to local-to-global domain mappings 136 and share those generated datasets with privacy-preserving aggregator 120. Then, in at least one embodiment privacy-preserving aggregator 120 may aggregate the collective datasets into an aggregated training dataset 126 to train a model 212 using one or more neural networks, such as one or more neural networks 110 as shown in FIG. 1.

FIG. 3 is a flow diagram illustrating at least one embodiment of a method for aggregating private local domains into a private global domain. The process begins at 300, where in at least one embodiment multiple clients, such as clients 130 of FIG. 1, may desire to contribute private datasets, such as private datasets 132 of FIG. 1, to be aggregated into a single dataset, such as aggregated training dataset 126 of FIG. 1. However, individual clients may not know a feature domain that is consistent across all clients. Therefore, in at least one embodiment a private global domain may be derived. This derived domain, however, may not be shared with individual clients in at least one embodiment, in order to prevent leakage of sensitive information to other clients of the system.

In at least one embodiment, individual ones of the clients may enumerate respective local, private domains, such as private domains 133 of FIG. 1, by pre-processing private domain data to enumerate local attribute values. In various embodiments, pre-processing may take any number of forms, however each of the clients perform such pre-processing and enumeration according to a same set of processing rules to ensure consistency of values during subsequent aggregation. In at least one embodiment, pre-processing of the data may include replicating some entries in the local private domains one or more times. By performing such replication, a client may hide a local private domain size from an aggregator or other participants.

In at least one embodiment, pre-processing may include applying a cryptographic hash function to individual elements of private domains of each client, where the cryptographic hash function may be randomized by a previously agreed upon key. By sharing hashes at an aggregation level, privacy of sensitive information may be increased, enabling potentially simpler and more computationally efficient implementation of a privacy-preserving aggregator, such as privacy-preserving aggregator 110 of FIG. 1, for example using a single computing device or cluster. In other embodiments, a privacy-preserving aggregator 120 may be implemented as multiple servers or clusters that employ secure multi-party computation (MPC), a cryptographic protocol that distributes a computation across multiple servers where no individual server can see data of other servers or a complete set of data. Using MPC, no individual device or entity may have access to private data of individual clients 130, as MPC secures private data, or secret data, by splitting processing into multiple parts such that no single participant knows underlying truths. With MPC, no single participant can reconstruct or leak secret information.

In at least one embodiment, as shown in 310, the individual clients may then each securely and privately share the enumerated local private domains, such as private domain values 134 of FIG. 1, with a privacy-preserving aggregator, such as privacy-preserving aggregator 120 of FIG. 1, such that privacy of the local, private domains themselves are preserved. In various embodiments, techniques may be employed to ensure privacy of individual ones of the private domain values such that information may not be leaked to the privacy-preserving aggregator or other entities.

For example, given an attribute A, let

$$Ax = \{ {a}_{1}^{x} , … , {a}_{{w}_{x}}^{x} \}$$

denotes the attribute domain of A at client Pₓ dataset, and there are wₓ unique values of Aₓ. To illustrate how the protocol works, assume there are three clients P₁, P₂, and P₃, and their local attribute domains of A are defined as:

$${A}^{1} = \{ a , b , c , e , f \}$$

$${A}^{2} = \{ a , b , f , g \}$$

$${A}^{3} = \{ a , c , f , g , h \}$$

In at least one embodiment, a privacy-preserving aggregator may as shown in 320 then aggregate shared enumerated local private domains by creating a union or concatenation of the enumerated local private domains of individual ones of the clients. In at least one embodiment, as a result of this aggregation a single aggregate of enumerated values may be created. However, a portion of the aggregate data may be non-unique values as different records of private datasets of different clients may include a same attribute value. Given the sample domains above:

$$[ A ] ← \{ [ a ] , [ b ] , [ c ] , [ e ] , [ f ] , [ a ] , [ b ] , [ f ] , [ g ] , [ a ] , [ c ] , [ f ] , [ g ] , [ h ] \}$$

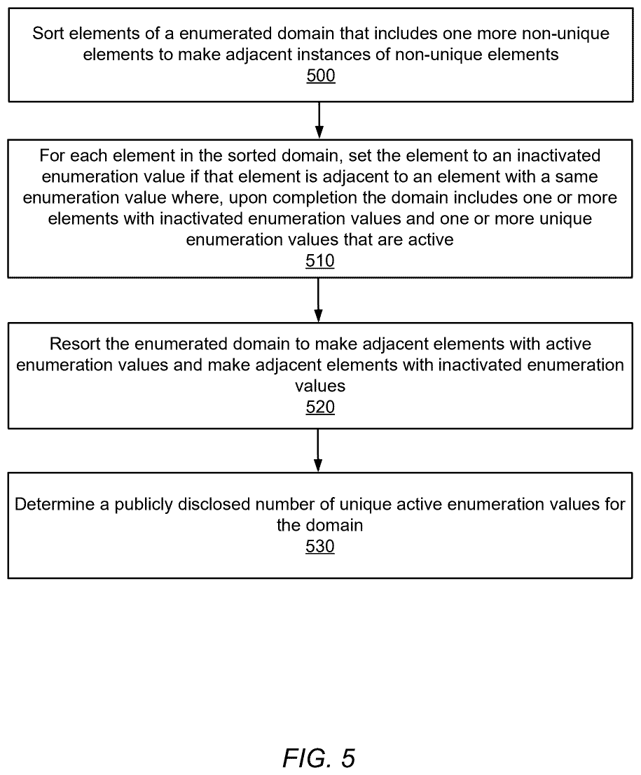

To generate a global domain for aggregation, non-unique values of the aggregate data may be eliminated, in at least one embodiment, as shown in 330. Any number of techniques may be employed to reduce the aggregate data to include only unique enumerations and to exclude non-unique values. At least one embodiment of eliminating non-unique enumerations is discussed below in FIG. 5, although this is merely one example and is not intended to be limiting. In at least one embodiment, sorting the aggregate data may yield:

$$[ A ] ← \{ [ a ] , [ a ] , [ a ] , [ b ] , [ b ] , [ c ] , [ c ] , [ e ] , [ f ] , [ f ] , [ f ] , [ g ] , [ g ] , [ h ] \}$$

Eliminating non-unique values may yield:

$$[ A ] ← \{ [ 0 ] , [ 0 ] , [ a ] , [ 0 ] , [ b ] , [ 0 ] , [ c ] , [ e ] , [ 0 ] , [ 0 ] , [ f ] , [ 0 ] , [ g ] , [ h ] \}$$

Where [0] indicates inactivated enumerations. In at least one embodiment, resorting the array may then move inactivated enumerations to the one end, yielding:

$$[ A ] ← \{ [ a ] , [ b ] , [ c ] , [ e ] , [ f ] , [ g ] , [ h ] , [ 0 ] , [ 0 ] , [ 0 ] , [ 0 ] , [ 0 ] , [ 0 ] , [ 0 ] \}$$

In at least one embodiment, a total number of unique enumerations may then be determined and made public to improve efficiency of subsequent computations. In other embodiments, global domain size may remain private to improve privacy of the global domain. It should be understood that different approaches to generating a global domain of unique enumerations may be envisioned and the above example is merely one possibility.

In at least one embodiment, as shown in 340, respective mappings for enumerations of the shared pre-processed data of the clients may be created, where each element of a mapping of a client may map to an enumerated value of a corresponding element in the private domain. Given the sample input domains above and the resulting domain of unique enumerations, mappings for the three sample clients may be:

$$[ {B}^{1} ] = \{ [ 1 ] , [ 2 ] , [ 3 ] , [ 4 ] , [ 5 ] \} \vert$$

$$[ {B}^{2} ] = \{ [ 1 ] , [ 2 ] , [ 5 ] , [ 6 ] \}$$

$$[ {B}^{3} ] = \{ [ 1 ] , [ 2 ] , [ 5 ] , [ 6 ] , [ 7 ] \}$$

In at least one embodiment, as shown in 350 a privacy-preserving aggregator may then securely and privately share the respective mappings with the respective clients, where the sharing preserves privacy for the global domain. The derived private global domain may, in at least one embodiment, not be disclosed to outside parties, including the clients, to preserve privacy of the private global domain and individual ones of the private domains.

FIG. 4 is a flow diagram illustrating at least one embodiment of a method for aggregating private local datasets into a private global dataset. Given a common, or global, domain for local dataset of multiple clients, or local mappings to a private global domain such as derived in FIG. 3 above, multiple clients, such as clients 130 of FIG. 1, may privately share datasets, such as private datasets 132 of FIG. 1, with a privacy-preserving aggregator, such as privacy-preserving aggregator 120 of FIG. 1, to generate an aggregated dataset, such as aggregated training dataset 126 of FIG. 1.

In at least one embodiment, as shown in 400 multiple clients may locally encode data of a private dataset. This encoding may include consistent pre-processing strategies, such as discretization, handling missing values, and so forth. In various embodiments, pre-processing may take any number of forms, however each of the clients may perform such pre-processing and enumeration according to a same set of processing rules to ensure consistency of values during subsequent aggregation. In at least one embodiment, clients may include one-hot encodings, an encoding technique where categorical variables are represent as numerical values. Each party's local one-hot encodings may be mapped consistently using local, private mappings to an undisclosed, private global attribute domain, such as local-to-global domain mapping 136 as shown in FIG. 1.

In at least one embodiment, as shown in 410, client may then securely and privately share the encoded data of private datasets, such as the private domain values 134 of FIG. 1, with a privacy-preserving aggregator, such as privacy-preserving aggregator 120 of FIG. 1, where the sharing preserves privacy of the private datasets of the respective clients.

In at least one embodiment, as shown in 420, a privacy-preserving aggregator may aggregate, concatenate, join or generate a union of the privately shared encoded data to generate an aggregated dataset, where the collective data is encoded in private, global domain not shared with the clients. The aggregated dataset may then be provided to additional processing, such as training a neural network 110 as shown in FIG. 1, in at least one embodiment.

FIG. 5 is a flow diagram illustrating at least one embodiment of a method for eliminating non-unique values of a domain. As shown in 500, in at least one embodiment, an enumerated domain that includes one or more non-unique elements may be received. For example, given an attribute A={a₁, . . . , a_{w}_{ₓ}} that denotes the attribute domain of A, a received domain may be:

$$[ A ] ← \{ [ a ] , [ b ] , [ c ] , [ e ] , [ f ] , [ a ] , [ b ] , [ f ] , [ g ] , [ a ] , [ c ] , [ f ] , [ g ] , [ h ] \}$$

In at least one embodiment, to generate a global domain for aggregation, non-unique values of the aggregate data may be eliminated In at least one embodiment, sorting the domain may yield:

$$[ A ] ← \{ [ a ] , [ a ] , [ a ] , [ b ] , [ b ] , [ c ] , [ c ] , [ e ] , [ f ] , [ f ] , [ f ] , [ g ] , [ g ] , [ h ] \}$$

In at least one embodiment, as shown in 510, a domain may be scanned, one element at a time, and individual elements set to an inactivated enumeration value, such as a zero value, if the element is adjacent to another element with a same enumeration value. For example, a domain may be scanned left-to-right starting at a first element, with the identified element set to an inactivated enumeration value if an element immediate to the right of the identified element exists and has a same enumeration value as the identified element, in at least one embodiment. It should be understood that this is merely and example and other scanning techniques may be envisioned in various embodiments. Upon completion of the scan, a domain may include one or more elements with inactivated enumeration values and one or more unique, active enumeration values. Eliminating non-unique values may yield:

$$[ A ] ← [ 0 ] , [ 0 ] , [ a ] , [ 0 ] , [ b ] , [ 0 ] , [ c ] , [ e ] , [ 0 ] , [ 0 ] , [ f ] , [ 0 ] , [ g ] , [ h ] \}$$

Where [0] indicates inactivated enumerations.

In at least one embodiment, as shown in 520, the domain of unique active enumeration values may then be resorted to make adjacent elements with active enumeration values and further make adjacent elements with inactivated enumeration values. The resulting domain may be:

$$[ A ] ← [ a ] , [ b ] , [ c ] , [ e ] , [ f ] , [ g ] , [ h ] , [ 0 ] , [ 0 ] , [ 0 ] , [ 0 ] , [ 0 ] , [ 0 ] , [ 0 ] \}$$

In at least one embodiment, as shown in 530, one or more inactivated enumeration values may be removed from the domain and a count of unique active enumeration determined. In at least one embodiment, the determined number of unique enumerations may then be made public to improve efficiency of subsequent computations. In other embodiments, global domain size may remain private and may preserve a number of inactivated enumeration values to improve privacy of the global domain. It should be understood that different approaches to generating a global domain of unique enumerations may be envisioned and the above example is merely one possibility.

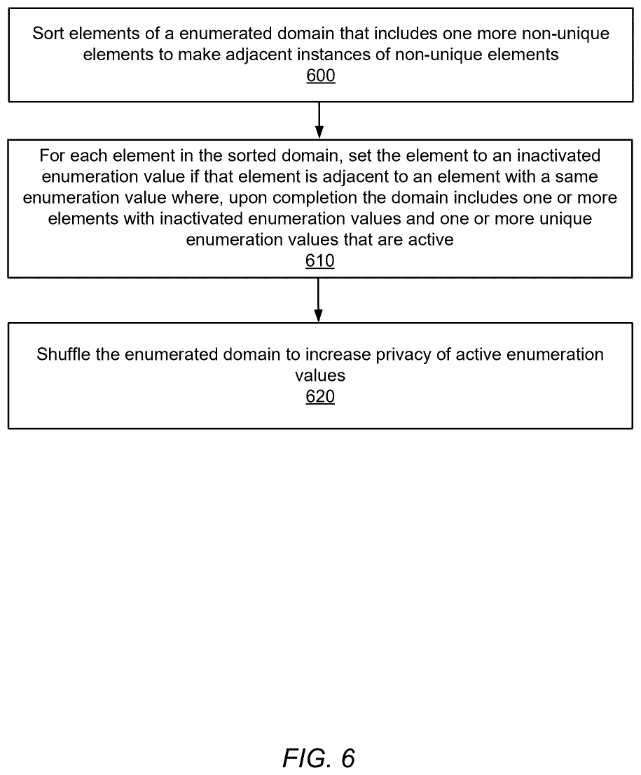

FIG. 6 is a flow diagram illustrating an alternative embodiment of a method for eliminating non-unique values of a domain with increased domain security. As shown in 600, in at least one embodiment, an enumerated domain that includes one or more non-unique elements may be received. For example, given an attribute A={a₁, . . . , a_{w}_{ₓ}} that denotes the attribute domain of A, a received domain may be:

$$[ A ] ← \{ [ a ] , [ b ] , [ c ] , [ e ] , [ f ] , [ a ] , [ b ] , [ f ] , [ g ] , [ a ] , [ c ] , [ f ] , [ g ] , [ h ] \}$$

In at least one embodiment, to generate a global domain for aggregation, non-unique values of the aggregate data may be eliminated In at least one embodiment, sorting the domain may yield:

$$[ A ] ← \{ [ a ] , [ a ] , [ a ] , [ b ] , [ b ] , [ c ] , [ c ] , [ e ] , [ f ] , [ f ] , [ f ] , [ g ] , [ g ] , [ h ] \}$$

In at least one embodiment, as shown in 610, a domain may be scanned, one element at a time, and individual elements set to an inactivated enumeration value, such as a zero value, if the element is adjacent to another element with a same enumeration value. For example, a domain may be scanned left-to-right starting at a first element, with the identified element set to an inactivated enumeration value if an element immediate to the right of the identified element exists and has a same enumeration value as the identified element, in at least one embodiment. It should be understood that this is merely and example and other scanning techniques may be envisioned in various embodiments. Upon completion of the scan, a domain may include one or more elements with inactivated enumeration values and one or more unique, active enumeration values. Eliminating non-unique values may yield:

$$[ A ] ← [ 0 ] , [ 0 ] , [ a ] , [ 0 ] , [ b ] , [ 0 ] , [ c ] , [ e ] , [ 0 ] , [ 0 ] , [ f ] , [ 0 ] , [ g ] , [ h ] \}$$

Where [0] indicates inactivated enumerations.

In at least one embodiment, as shown in 520, the domain of unique active enumeration values may then be shuffled to further increase privacy of active enumeration values.

Some of the mechanisms described herein may be provided as a computer program product, or software, that may include a non-transitory, computer-readable storage medium having stored thereon instructions which may be used to program a computer system 2000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

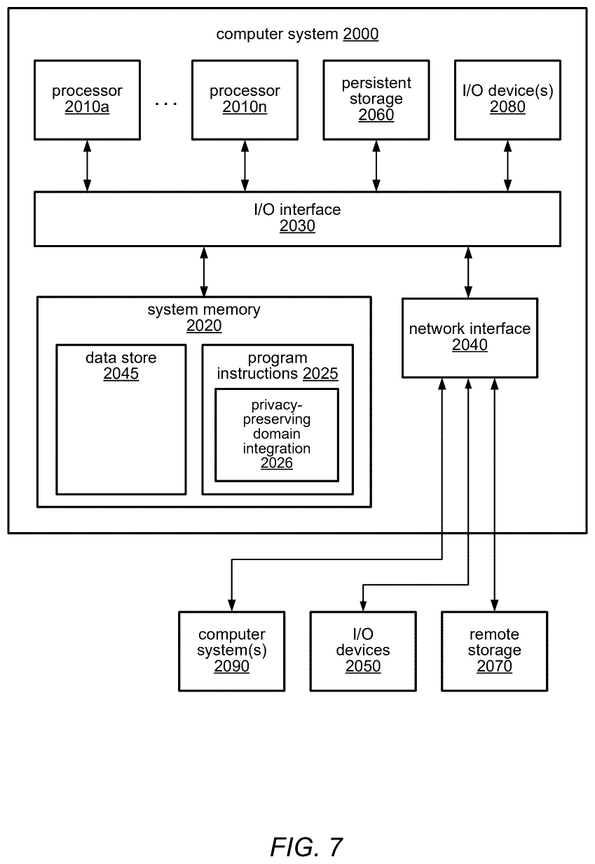

Any of various computer systems may be configured to implement processes associated with a technique for multi-region, multi-primary data store replication as discussed with regard to the various figures above. FIG. 7 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 7 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for privacy-preserving domain integration as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 7 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A computer-implemented method, comprising:
aggregating, at a dataset aggregator, respective sets of private values secretly shared by individual clients of a plurality of clients to generate an aggregate set of private values comprising a plurality of non-unique values, wherein individual sets of the respective sets of private values are encoded according to respective private domains not shared with the dataset aggregator;
generating a private global domain comprising respective unique ordinal values for individual unique values of the aggregate set of private values; and
sharing, to individual clients of the plurality of clients, respective sets of mappings individually comprising respective unique ordinal values of the private global domain for individual private values of the respective sets of private values shared by the individual clients, wherein sharing the respective sets of mappings preserves privacy of the private global domain.

2. The computer-implemented method of claim 1, further comprising:
sharing, by individual clients of the plurality of clients, respective sets of values encoded according to the respective sets of mappings shared by the dataset aggregator; and
integrating, by the dataset aggregator, the respective sets of values to generate an aggregate set of values encoded according to the private global domain.

3. The computer-implemented method of claim 1, wherein the respective sets of private values individually comprise one or more unique numerical values generated according to a one-hot encoding technique.

4. The computer-implemented method of claim 1, wherein a set of the respective sets of private values secretly shared by individual clients of a plurality of clients comprises at least one non-unique value to preserve privacy of a respective private domain of the set.

5. The computer-implemented method of claim 1, wherein a number of the respective unique ordinal values of the private global domain is greater than a number of unique values of the aggregate set to preserve privacy of the private global domain.

6. The computer-implemented method of claim 1, wherein the respective sets of private encodings are generated from respective private datasets of the individual clients according to a set of encoding rules shared among the plurality of clients.

7. The computer-implemented method of claim 6, wherein the set of encoding rules comprises a rule directing encoding individual values of the respective sets of private values according hash function randomized by a key shared among the plurality of clients.

8. One or more non-transitory computer-accessible storage media storing program instructions that when executed on or across one or more processors cause the one or more processors to perform:
aggregating, at a dataset aggregator, respective sets of private values secretly shared by individual clients of a plurality of clients to generate an aggregate set of private values comprising a plurality of non-unique values, wherein individual sets of the respective sets of private values are encoded according to respective private domains not shared with the dataset aggregator;
generating a private global domain comprising respective unique ordinal values for individual unique values of the aggregate set of private values; and
sharing, to individual clients of the plurality of clients, respective sets of mappings individually comprising respective unique ordinal values of the private global domain for individual private values of the respective sets of private values shared by the individual clients, wherein sharing the respective sets of mappings preserves privacy of the private global domain.

9. The one or more non-transitory computer-accessible storage media of claim 8, wherein the instructions that when executed on or across one or more processors cause the one or more processors to further perform:
sharing, by individual clients of the plurality of clients, respective sets of values encoded according to the respective sets of mappings shared by the dataset aggregator; and
integrating, by the dataset aggregator, the respective sets of values to generate an aggregate set of values encoded according to the private global domain.

10. The one or more non-transitory computer-accessible storage media of claim 8, wherein the respective sets of private values individually comprise one or more unique numerical values generated according to a one-hot encoding technique.

11. The one or more non-transitory computer-accessible storage media of claim 8, wherein a set of the respective sets of private values secretly shared by individual clients of a plurality of clients comprises at least one non-unique value to preserve privacy of a respective private domain of the set.

12. The one or more non-transitory computer-accessible storage media of claim 8, wherein a number of the respective unique ordinal values of the private global domain is greater than a number of unique values of the aggregate set to preserve privacy of the private global domain.

13. The one or more non-transitory computer-accessible storage media of claim 8, wherein the respective sets of private encodings are generated from respective private datasets of the individual clients according to a set of encoding rules shared among the plurality of clients.

14. The one or more non-transitory computer-accessible storage media of claim 13, wherein the set of encoding rules comprises a rule directing encoding individual values of the respective sets of private values according hash function randomized by a key shared among the plurality of clients.

15. A system, comprising:
a plurality of clients individually comprising one or more processors and a memory;
a dataset aggregator comprising one or more processors and a memory and configured to:
aggregate respective sets of private values secretly shared by individual clients of the plurality of clients to generate an aggregate set of private values comprising a plurality of non-unique values, wherein individual sets of the respective sets of private values are encoded according to respective private domains not shared with the dataset aggregator;
generate a private global domain comprising respective unique ordinal values for individual unique values of the aggregate set of private values; and
share, to individual clients of the plurality of clients, respective sets of mappings individually comprising respective unique ordinal values of the private global domain for individual private values of the respective sets of private values shared by the individual clients, wherein sharing the respective sets of mappings preserves privacy of the private global domain.

16. The system of claim 15, wherein individual clients of the plurality of clients are configured to share respective sets of values encoded according to the respective sets of mappings shared by the dataset aggregator; and wherein the dataset aggregator is further configured to integrate the respective sets of values to generate an aggregate set of values encoded according to the private global domain.

17. The system of claim 15, wherein the respective sets of private values individually comprise one or more unique numerical values generated according to a one-hot encoding technique.

18. The system of claim 15, wherein a set of the respective sets of private values secretly shared by individual clients of a plurality of clients comprises at least one non-unique value to preserve privacy of a respective private domain of the set.

19. The system of claim 15, wherein a number of the respective unique ordinal values of the private global domain is greater than a number of unique values of the aggregate set to preserve privacy of the private global domain.

20. The system of claim 15, wherein the respective sets of private encodings are generated from respective private datasets of the individual clients according to a set of encoding rules shared among the plurality of clients.
